(19) United States
(12) Patent Application Publication
(10) Pub. No.: US 2002/0137584 A1
(43) Pub. Date: Sep. 26, 2002

(54) Low noise rocker pin type silent chain

(76) Inventors: Hiroshi Horie, Osaka (JP); Kazumasa Matsuno, Osaka (JP); Shigekazu Fukuda, Osaka (JP); Takayuki Funamoto, Osaka (JP); Yoshinori Iwasaki, Osaka (JP); Kenshi Suzuki, Osaka (JP)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/104,705

(22) Filed: Mar. 22, 2002

(30) Foreign Application Priority Data
Mar. 26, 2001 (JP) 087878/2001

(51) Int. Cl. F16G 13/04

(52) U.S. Cl. 474/213; 474/212; 474/215

(57) ABSTRACT

A rocker pin type silent chain in which a joint row and a guide row are arranged in alternation and their link plates are interleaved and articulably connected by long and short rocker pins. The linear pitch, defined by the separation of points on a pitch line intersected by lines tangent to the rolling surfaces of the rocker pins at the contact point when the chain is in a straight condition, is made equal to the chordal pitch, defined by the linear distance between intersection of similar lines with a pitch circle when adjacent links are bent as the chain is wrapped around a sprocket. With a silent chain thus constructed each link in the silent chain meshes properly with the teeth of the sprocket torque is distributed uniformly over the teeth in mesh with the sprocket.

### BACKGROUND OF THE INVENTION

This invention relates to a silent chain in which the link plates are connected by rocker pins.

A silent chain is a chain, looped between a pair of sprockets, for transferring power from a drive sprocket to a driven sprocket. A rocker pin type silent chain usually includes joint rows and guide rows in an alternating, interleaved arrangement, the latter including one or more guide plates as well as link plates. The joint rows and guide rows are articulably connected to one another by rocker pins. Each link plate, whether in the joint row or in the guide row, has a pair of pin holes and a pair of teeth. Each of the rocker pins is composed of a longer pin and a shorter pin, and extends through, and fits into, the aligned pin holes of the interleaved plates. When fitted into the aligned pin holes of the interleaved link plates, the longer and shorter rocker pins are in rolling contact with each other. Thus, when the chain bends as it moves around a sprocket past a chain guide or the like, the longer and shorter pins roll against each other.

A silent chain is typically used for power transfer between a pair of sprockets in a vehicle. Whether it be of the round pin type or the rocker pin type, the chain is designed by first taking into account the distance between the shafts of the sprockets. The distance between the shafts is determined by the overall size of the power transfer mechanism, and accordingly the design of parts and design changes are dependent on the overall size of the mechanism.

When the distance between the shafts of the pair of sprockets is determined, the silent chain is then designed by determining the linear pitch of the silent chain, and determining the pitch circles of the sprockets. The linear pitch of a rocker type silent chain refers to the distance between two points obtained when the contact points between the long and short pins of each of two successive rocker pins in the chain are projected onto a pitch line, i.e. a straight line passing through the centers of successive pin holes of the chain when the chain is in a straight condition. The long and short elements actually contact each other along lines of contact, but the lines of contact are referred to as contact points since they appear as points in two-dimensional elevational views of the chain. The pitch of the silent chain, then, is the distance between the projected points on the pitch line. The circular pitch of the sprocket is the length of the arc between the adjacent pitch points on the pitch circle.

The shape and size of the rocker pin, and the shape and size of the link plate and the like, are determined based on the pitch of the silent chain, the circular pitch of the sprocket, the number of teeth and the tooth shape of the sprocket teeth, and the pitch circle diameter of the sprocket.

In the relationship between a silent chain and its sprocket, there is a special characteristic which is not found in the relationship between a roller chain and a sprocket. The special characteristic resides in that, when the silent chain is in mesh with the sprocket, the pitch circle of the silent chain and the pitch circle of the sprocket are different from each other. In the above designing process, the linear pitch of the silent chain is determined, but the circular pitch, or the chordal pitch, obtained when the silent chain is wrapped around the sprocket is not satisfactorily determined. Therefore, when the circular pitch of the sprocket is designed with reference to the pitch of the silent chain, there is a difference between the pitch determined for a chain in a straight condition, and its chordal pitch.

When there is a difference between the pitch of the silent chain and its chordal pitch, the ability of the links to share the load is lost. For example, when fifteen teeth of a sprocket having thirty teeth mesh with a silent chain, it is preferable that the torque be uniformly distributed over those fifteen teeth of the sprocket and the links of the chain in mesh with the sprocket. However, when the circular pitch and other parameters of the sprocket are designed based on the pitch of the silent chain, the loads borne by the sprocket teeth and by the chain links engaged with the sprocket teeth become nonuniform. Specifically the loads on the sprocket teeth and the chain link are biased either to the meshing side or to the unmeshing side of the sprocket. The unbalanced load distribution results in increased momentary loads on specific teeth and specific links, and accordingly the strength of the silent chain must be made greater in order to bear these increased loads.

### SUMMARY OF THE INVENTION

It is, accordingly, a general object of the invention to overcome the problems associated with the above-mentioned conventional silent chains.

A more specific object of the invention is to provide a silent chain in which links bear the load more uniformly when the silent chain is wrapped around a sprocket.

A rocker pin type silent chain according to one aspect of the invention comprises alternately disposed and interleaved joint rows and guide rows, each row being composed of link plates, each having a pair of pin holes and a pair of teeth, and rocker pins arranged in succession and articulably connecting the plates of each row with the plates of adjacent rows. Each of the rocker pins comprises a longer pin and a shorter pin, both having arcuate backs contacting each other at a contact point, and extends through, and fitting into, pin holes in an interleaved joint row and guide row. The chain has a linear pitch, defined by the distance between points of intersection of a straight pitch line extending through the centers of pin holes of the chain with lines tangent to the contact points of the backs of the longer and shorter pins of two successive rocker pins when the chain is in a straight condition. The chain also has a chordal pitch, defined by the linear distance between the points of intersection of a pitch circle extending through the centers of pin holes of the chain with lines tangent to the contact points of the backs of the longer and shorter pins of two successive rocker pins when the chain is bent around a sprocket. The chain of the invention is characterized by the fact that the linear pitch and the chordal pitch are equal.

Preferably, the linear pitch of the chain and its chordal pitch are equal when the chain is wrapped around the smallest sprocket in a power transfer system comprising the chain and a plurality of sprockets in mesh with the chain.

When the silent chain is in a straight condition, its pitch is defined on the pitch line in accordance with the separation of the rocker pins. On the other hand, when the silent chain is wrapped around sprockets, its chordal pitch is defined by a chord of a pitch circle between points at which the pitch circle is intersected by lines tangent to the contacting faces of the pins of successive rocker pins. In other words, the pitch in the silent chain would correspond to the distance between the centers of the pin holes if the silent chain were a rigid body, if there were no space between the pin holes and the rocker pins therein, and if the pin holes in the interleaved links were matched with one another. The chordal pitch in the silent chain would also correspond to the distance between the centers of the pin holes under the same conditions.

When the pitch between the centers of the pin holes in the chain when straight, and the chordal pitch between the centers of the pin holes when the chain is bent around a sprocket, are made equal to each other, the silent chain will be properly meshed with a sprocket produced with reference to the pitch of the chain. Accordingly, torque is distributed uniformly over all the meshing teeth and over all the meshing links, excessive local loads are avoided, and a chain of a given size will have optimum strength. Conversely, a smaller silent chain can be used to meet a given torque transmitting requirement.

### BRIEF DESCRIPTION OF THE DRAWINGS

Preferred embodiments of the invention will now be described in detail, with reference to the accompanying drawings, in which:

FIG. 1 is a front elevational view of a silent chain according to the invention;

FIG. 2 is a front elevational view of a guide link row of a silent chain in accordance with the invention, with the guide plate removed, showing the pitch line and the pitch of the silent chain when in a straight condition;

FIG. 3 is a front elevational view of a guide link row of a silent chain in accordance with the invention, with the guide plate removed, showing the chain in a bent condition and in mesh with a sprocket, and illustrating a pitch circle, and the chordal pitch;

FIG. 4 is an enlarged view showing the relationship between the contact point between rolling surfaces of the rocker pin elements when the in chain is straight, and the corresponding contact point when the chain is bent; and

FIG. 5 is a further enlarged view showing in greater detail the relationship of the contact points as shown in FIG. 4.

### DETAILED DESCRIPTION OF THE PREFERRED EMBODIMENTS

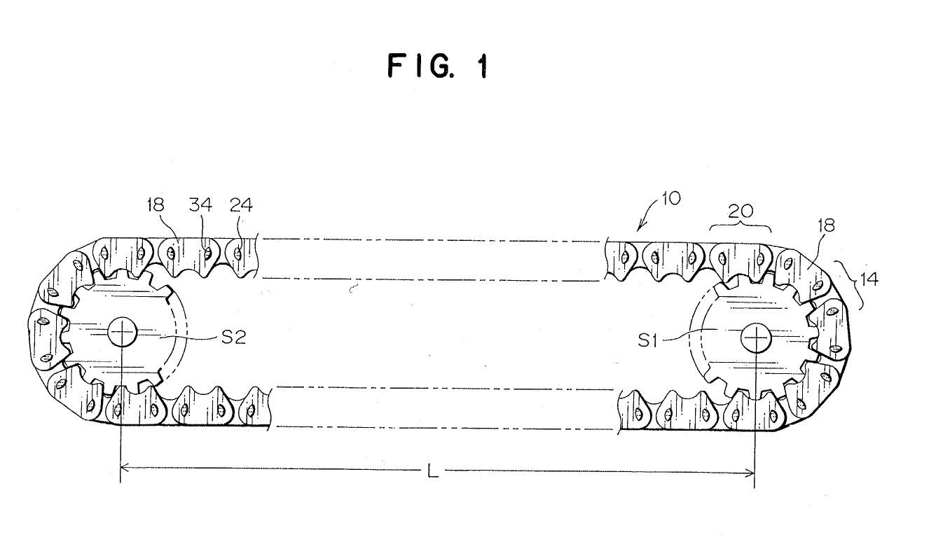

FIG. 1 shows an example of use of a silent chain 10 and a pair of sprockets S1 and S2 in a power transfer device of a vehicle. A pair of sprockets S1 and S2, whose specifications are the same or similar to each other, is used. The silent chain 10 is looped over the respective sprockets to effect torque transfer from a drive shaft to a driven shaft.

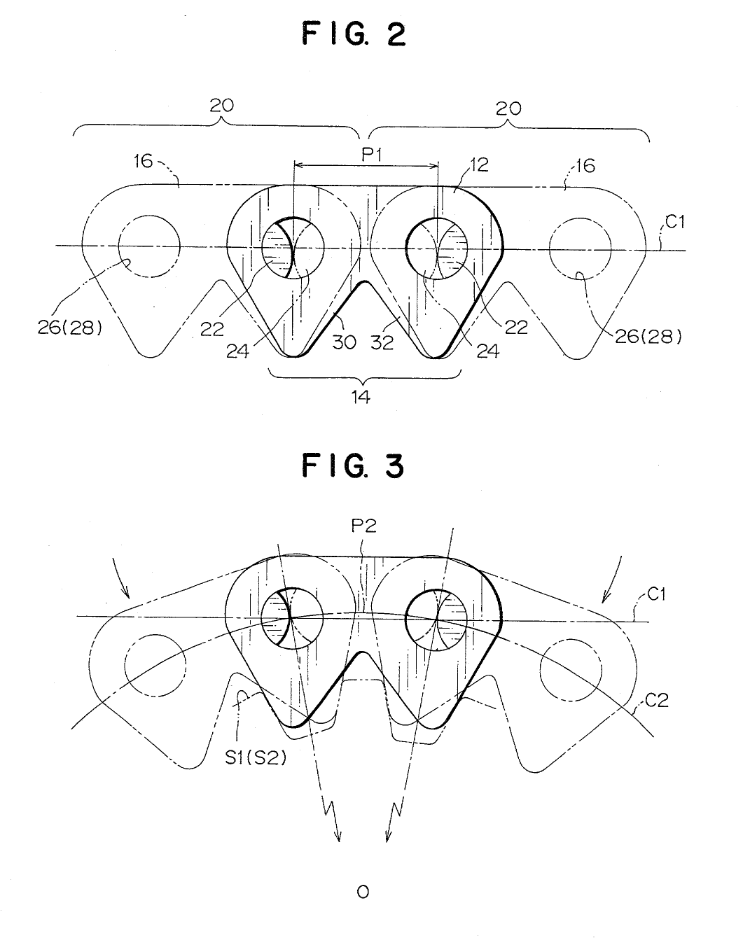

In the silent chain 10, joint rows 14, each composed of N (N≧2) link plates 12, and guide rows 20, each composed of (N−1) link plates 16 and two guide plates 18, are combined with one another in alternating relationship, and articulably connected to by rocker pins 22, 24 (FIGS. 2 and 3).

As shown in FIGS. 2 and 3, each of the link plates 12 and 16 in the respective guide rows and link rows, include a pair of pin holes 26 and 28 and a pair of teeth 30 and 32. Of the two rocker pins, 22 and 24, pin 24 is longer and pin 22 is shorter. Each end of each of the longer rocker pins 24 is fitted into, and attached to, a non-circular pin hole 34 of a guide plate 18 (FIG. 1). The shorter pin 22 and the longer pin 24 have substantially the same cross-sectional shape and rolling surfaces. Each rocker pin element 22 and 24 has an arc-shaped rolling surface R. The shorter pin 22 and the longer pin 24 are inserted into the pin holes 26 and 28 with their rolling surfaces R opposed to and adjacent each other. Each of the rolling surfaces R may include a plurality of curved surfaces, which join one another smoothly and without a discontinuity.

With the chain in tension, the longer pin 24 is engaged with edges of the pin holes of the link plates 16 of a guide row, and the shorter pin 22 is engaged with edges of the pin holes of the link plates 12 of a joint row 14. As shown in FIG. 2, the rolling surface of the shorter pin 22 and the rolling surface of the longer pin 24 are in contact with each other. The pitch line C1 of the silent chain 10, passes through the centers of the pin holes 26 and 28.

The pitch P1 of the silent chain 10, when in a straight condition, is defined by the distance between the centers of the pin holes 26 and 28. Here, since the center of the pin hole 26 does not necessarily coincide exactly with the center of the pin hole 28 due to clearance or the like, the center of the pin hole is defined as a point midway between the centers of the respective pin holes 26 and 28.

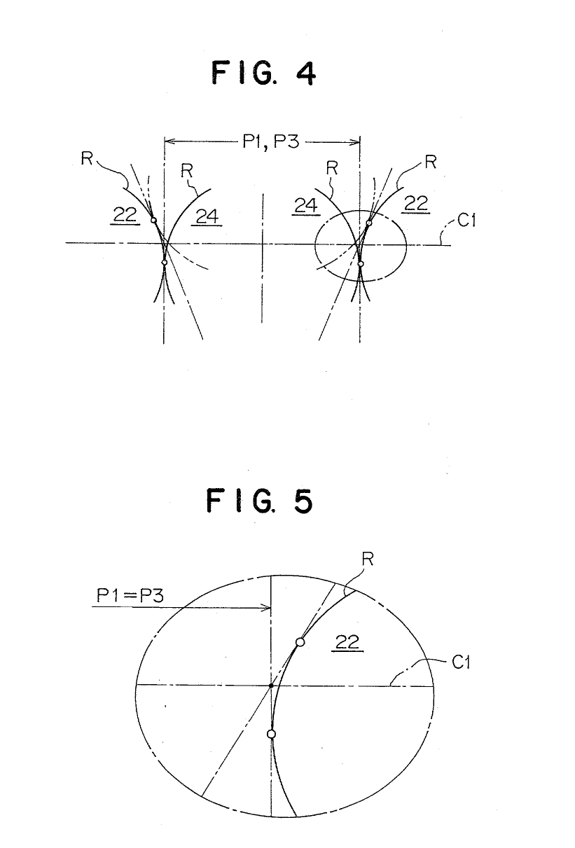

As shown in FIG. 4, the contact point between the rolling surfaces R is, by design, at a position below the pitch line C1, that is, on the inner or tooth side of the pitch line C1. Thus, the contact between the rolling surfaces does not coincide with the centers of the pin holes 26 and 28. However, the distance between points where the contact points of the rolling surfaces are projected onto the pitch line C1 coincides with the distance between the centers of the pin holes 26 and 28. Each such projection is along a line tangent to both rolling surfaces at the point of contact, and extends perpendicular to the pitch line C1.

In FIG. 3 adjacent links are bent at an angle as the silent chain is wrapped around a sprocket. The shorter pin 22 in the link plates 12 of the joint row 14 and the longer pin 24 in the link plates 16 of the guide row 20 roll on each other while in contact with each other. In FIG. 3, the pitch line C1 of the chain 10 passes through the centers of the pin holes 26 and 28, and the pitch circle C2 of the chain 10 also passes through the centers of the pin holes 26 and 28.

The circular pitch P2 of the chain 10 is defined by the length of the arc between the centers of the pin holes 26 and 28.

As shown in FIG. 4, the contact between the rolling surfaces R of the rocker pin elements 22 and 24 is, by design, located above the pitch line C1, that is toward the outer or back side of the chain relative to the pitch circle C2, when the chain is bent. Accordingly, the contact point between the rolling surfaces does not coincide with the centers of the pin holes 26 and 28. However, the points where the contact points between the rolling surface are projected onto the pitch line C1 or the pitch circle C2, in directions tangent to the rolling surfaces at their point of contact, coincide with the centers of the pin holes 26 and 28. The linear distance between these points on the pitch circle linear pitch is defined as the chordal pitch P3.

When the silent chain is bent, as shown in FIG. 3, lines tangent to the rolling surfaces at their points of contact are directed toward the center of the sprocket. Each such tangent line passes through the center of a pin hole. Accordingly, the angle defined by the points of contact of the rolling surfaces of successive rocker pins and the center of the sprocket, the angle formed by the centers of the pin holes 26 and 28 and the center of the sprocket, and the angle corresponding to the circular pitch of the sprocket coincide with one another.

As described above, in accordance with the invention, the rolling surfaces R of the rocker pins 22 and 24 as to intersect the pitch line C1 and the pitch circle C2 in the silent chain both in its straight condition and in its bent condition. The centers of the pin holes 26 and 28 on the pitch line C1 or the pitch circle C2 are intersected by a line tangent to the rolling surfaces R at their contact point both when the chain is in a straight condition and when the chain is bent. The pitch of the silent chain is selected with reference to the distance L between the shafts of the sprockets in the designing stage. Even if the pitch, the number of teeth, and shape of the sprocket teeth are predetermined, the pitch of the silent chain in its straight condition, and its chordal pitch, can be matched to each other by properly designing the shape of the rocker pin.

By matching the pitch of the silent chain to the chordal pitch, even if the silent chain and the sprocket are designed separately, the respective links in the silent chain mesh properly with the teeth of the sprocket. As a result, the links of the silent chain that are engaged with the sprocket bear torque uniformly, so that no specific link bears an excessive load, which is one of causes of the breakage in a conventional silent chain.

In the above-described embodiment the pair of sprockets had the same specifications. However, the silent chain can be used in cases, such as in a power transfer device of a vehicle, where the sprockets have different specifications. In such a case, it is preferable that the silent chain be designed based on the angle between adjacent link rows when the chain is wrapped around the smallest sprocket in the power transfer device. This is because the angle between adjacent links becomes minimum at the location at which the chain is engaged with the smallest sprocket, and the number of links which mesh with the teeth of the smallest sprocket is also at a minimum. The object of the invention is to reduce the load on each link of the silent chain. Accordingly, the rocker pins are preferably designed so as to define the pitch and the chordal pitch based on the bend angle with reference to the smallest sprocket, so that the strength of the entire silent chain can be improved.

Obviously, various minor changes and modifications of the invention are possible in the light of the above teaching. It is therefore to be understood that within the scope of the appended claims, the invention may be practiced otherwise than as specifically described.

What is claimed is:

1. A rocker pin type silent chain comprising:
alternately disposed and interleaved joint rows and guide rows, each row being composed of link plates, each having a pair of pin holes and a pair of teeth; and
rocker pins arranged in succession and articulably connecting the plates of each row with the plates of adjacent rows, each of said rocker pins comprising a longer pin and a shorter pin, both the longer pin and the shorter pin of each rocker pin having arcuate backs contacting each other at a contact point, and extending through and fitting into pin holes in an interleaved joint row and guide row;
wherein the chain has a linear pitch, defined by the distance between points of intersection of a straight pitch line extending through the centers of pin holes of the chain with lines tangent to the contact points of the backs of the longer and shorter pins of two successive rocker pins when the chain is in a straight condition;
wherein the chain has a chordal pitch, defined by the linear distance between the points of intersection of a pitch circle extending through the centers of pin holes of the chain with lines tangent to the contact points of the backs of the longer and shorter pins of two successive rocker pins when the chain is bent around a sprocket; and
wherein the linear pitch and the chordal pitch are equal.

2. The rocker pin type silent chain according to claim 1, in which the linear pitch of the chain and its chordal pitch are equal when the chain is wrapped around the smallest sprocket in a power transfer system comprising the chain and a plurality of sprockets in mesh with the chain.

3. A power transfer system comprising at least two sprockets, and a rocker pin type silent chain wrapped around said sprockets and arranged to transmit torque from one of said sprockets to another of said sprockets, the chain comprising:
alternately disposed and interleaved joint rows and guide rows, each row being composed of link plates, each having a pair of pin holes and a pair of teeth; and
rocker pins arranged in succession and articulably connecting the plates of each row with the plates of adjacent rows, each of said rocker pins comprising a longer pin and a shorter pin, both the longer pin and the shorter pin of each rocker pin having arcuate backs contacting each other at a contact point, and extending through and fitting into pin holes in an interleaved joint row and guide row;
wherein the chain has a linear pitch, defined by the distance between points of intersection of a straight pitch line extending through the centers of pin holes of the chain with lines tangent to the contact points of the backs of the longer and shorter pins of two successive rocker pins when the chain is in a straight condition;
wherein the chain has a chordal pitch, defined by the linear distance between the points of intersection of a pitch circle extending through the centers of pin holes of the chain with lines tangent to the contact points of the backs of the longer and shorter pins of two successive rocker pins when the chain is bent around one of said sprockets; and
wherein the linear pitch and the chordal pitch are equal.

4. A power transfer system comprising two sprockets of different diameters, and a rocker pin type silent chain wrapped around said sprockets and arranged to transmit torque from one of said sprockets to the other of said sprockets, the chain comprising:
alternately disposed and interleaved joint rows and guide rows, each row being composed of link plates, each having a pair of pin holes and a pair of teeth; and
rocker pins arranged in succession and articulably connecting the plates of each row with the plates of adjacent rows, each of said rocker pins comprising a longer pin and a shorter pin, both the longer pin and the shorter pin of each rocker pin having arcuate backs contacting each other at a contact point, and extending through and fitting into pin holes in an interleaved joint row and guide row;
wherein the chain has a linear pitch, defined by the distance between points of intersection of a straight pitch line extending through the centers of pin holes of the chain with lines tangent to the contact points of the backs of the longer and shorter pins of two successive rocker pins when the chain is in a straight condition;
wherein the chain has a chordal pitch, defined by the linear distance between the points of intersection of a pitch circle extending through the centers of pin holes of the chain with lines tangent to the contact points of the backs of the longer and shorter pins of two successive rocker pins when the chain is bent around the one of said sprockets having the smaller diameter; and
wherein the linear pitch and the chordal pitch are equal.
